(19) United States
(12) Patent Application Publication
(10) Pub. No.: US 2022/0231375 A1
(43) Pub. Date: Jul. 21, 2022

(54) A BATTERY MODULE

(71) Applicant: GRENLAND ENERGY AS, Nesttun, Bergen (NO)

(72) Inventors: Peter Nilsen Thysted, Langesund (NO); Roman Maximillian Stoiber, Porsgrunn (NO); Lars Ole Valøen, Skien (NO); Lars Brisendal, Heistad (NO); Per Øyvind Dammen, Skien (NO); Andreas Nødtvedt Malme, Skein (NO); Karl Kristian Markmann, Stavern (NO)

(73) Assignee: CORVUS ENERGY AS, Nesttun, Bergen (NO)

(21) Appl. No.: 17/613,633

(22) PCT Filed: May 28, 2020
(86) PCT No.: PCT/IB2020/055073

§ 371 Date: Nov. 23, 2021

(30) Foreign Application Priority Data
May 28, 2019 (NO) 20190681

(51) Int. Cl. H01M 50/30; H01M 50/583; H01M 50/505; H01M 50/213; H01M 50/581

(52) U.S. Cl. CPC H01M 50/30; H01M 50/583; H01M 50/581; H01M 50/213; H01M 50/505

(57) ABSTRACT

Present embodiments disclosure discloses a battery module, which includes a plurality of battery cells, a busbar, a cover member, an insulator member positioned between the plurality of battery cells, and a casing element enclosing all the above. The cover member positioned above the busbar. The cover member includes an elongated body defining a first major surface and a second major surface, where the second major surface is defined with a plurality of grooves. The cover member also includes a plurality of dimples are defined along at least one of the first major surface and the second major surface. Further, at least one dimple of the plurality of dimples melt and form an aperture when at least one battery cell of the battery module undergoes a thermal runaway, to fluidly connect the first major surface with the plurality of grooves.

### TECHNICAL FIELD

Present disclosure, in general, relates to the field of electrical engineering. Particularly, but not exclusively, the present disclosure relates to a rechargeable battery module including a plurality of battery cells. Further, embodiments of the present disclosure relate to an arrangement for ventilating gases in the battery module during thermal runaway.

### BACKGROUND

Due to high consumption of non-renewable resources and rapid decrease in its quantum, modern manufacturers have opted to manufacture machineries that may operate on renewable energy as an alternative energy source. With advent of technology, manufacturing of machineries which may be primarily operated by electrical energy has been on the rise. Such machineries require continuous supply of energy for efficient working. Some of the machineries may be including, but not limited to, vehicles, ferries, tools, and the like, which require continuous supply of energy. Generally, electrical energy may be stored in a storage medium commonly referred as a battery system comprising one or more battery modules, which in turn, may include a plurality of battery cells for storing electrical energy. Electrical energy stored in the battery system may be utilised for operation of the machineries. The battery module may be portable, rechargeable and may be made available in various power supply capacities, for suitably employing in operating machineries, and hence, may be a predominant alternative for the non-renewable resources.

Conventional battery cells in the battery module may in certain circumstances exhibit internal short-circuits and heat up. Some of these internal short-circuits may result in increased self-discharge rates, but occasionally such internal short-circuit conditions may lead to an overheating of the battery cell. In such an overheating situation, battery cells may emit or release flammable, toxic and hot gases therefrom, during conversion of chemical energy into electrical energy, where such gases may be entrapped within the battery module. These flammable, hot and toxic gases may tend to heat up the battery module and may transfer heat to some of the battery cells. This way, some of the battery cells may also be subjected to an elevated temperature at localized regions of the battery module. The elevated temperature in the battery module may disrupt regular conversion of the chemical energy into electrical energy and may in-turn cause overload in producing electrical energy from the plurality of battery cells. This may cause the plurality of battery cells to undergo combustion, resulting to a thermal runaway in the battery module. The combustion of some of the battery cells may damage various components of the battery module such as, but not limited to, battery cells located in the vicinity, busbar, burn-out of electrical wiring, casing, and the like, which may not be desirable.

Efforts are made in the past in order to modify the battery module to ventilate the hot gases entrapped in the battery module. One such conventional arrangement employed is discussed in U.S. Pat. No. 10,158,102 B2 [hereafter referred to as '102 patent]. The '102 patent discloses an electrical energy storage device for powering portable devices. The storage device includes barriers to minimize migration of thermal energy and propagation of combustion in the rare event that electrical energy storage cells fail, burst and ignite. The storage device consists of biased vents, which are configured to open during thermal event of one or more cells in the storage device. The biased vents are configured to open when pressure in the storage device exceeds a predefined value due to thermal event. However, it may not be reliable to delay opening of the biased vents till the pressure in the storage device exceeds the predefined value, as hot gases in the storage device may thermally affect surrounding battery cells prior to being vented therefrom.

Alternatively, modifications have also been performed in components of the battery module such as, the busbar, in order to restrict electrical damages to other components due to thermal runaway. One such conventional arrangement employed is discussed in Japanese patent number JP3219703U B2 [hereafter referred to as '703 patent]. The '703 patent discloses a busbar, provisioned with a bridge portion, where the bridge portion is configured to connect the busbar with a terminal of a battery. The bridge portion is configured to melt and electrically disconnect the battery terminal and the busbar, during abrupt large current production from the battery.

However, the conventional systems particularly focus on minimizing electrical damage due to thermal runaway of the battery cells, and do not effectively disclose aspects to reduce thermal damage to other battery cells of the battery module.

The present disclosure is directed to overcome one or more limitations stated above or any other limitations associated with the prior arts.

### SUMMARY OF THE DISCLOSURE

One or more shortcomings of conventional devices or systems are overcome and additional advantages are provided through the devices and the system as claimed in the present disclosure. Additional features and advantages are realized through the techniques of the present disclosure. Other embodiments and aspects of the disclosure are described in detail herein and are considered a part of the claimed disclosure.

In one non-limiting embodiment of the present disclosure, a cover member for a battery module is disclosed. The cover member includes an elongated body defining a first major surface and a second major surface, where the second major surface is defined with a plurality of grooves. The cover member also includes a plurality of dimples that are defined along at least one of the first major surface and the second major surface. Further, at least one dimple of the plurality of dimples melt and forms an aperture when at least one battery cell of the battery module undergoes a thermal runaway, to fluidly connect the first major surface with the plurality of grooves.

In an embodiment of the present disclosure, each dimple of the plurality of dimples is positioned at an intersection of at least two grooves of the plurality of grooves. Further, each groove of the plurality of grooves is separated by a ridge defined on the second major surface.

In an embodiment of the present disclosure, the second major surface abuts a casing element, to cover the plurality of grooves.

In an embodiment of the present disclosure, thermal conductivity of the casing element is higher than the elongated body.

In an embodiment of the present disclosure, the elongated body is made of a self-extinguishing polymer material.

In an embodiment of the present disclosure, each of the plurality of dimples is defined in a portion of the elongated body, between the first major surface and the second major surface.

In an embodiment of the present disclosure, a depth of each of the plurality of dimples is at least 15% of a thickness of the elongated body.

In another non-limiting embodiment of the present disclosure, a busbar for a battery module is disclosed. The busbar includes a base member, defining a plurality of contact portions. Each of the plurality of contact portions include a contact pad and a connecting arm extending between the contact pad and the base member, along a partial circumference of the contact pad. The busbar also includes a metal substrate, deposited along a portion of the connecting arm. The connecting arm and the metal substrate are configured to fuse, during thermal runaway in the battery module.

In an embodiment of the present disclosure, the connecting arm fuses to disable connection between the contact pad and the base member, during thermal runaway.

In an embodiment of the present disclosure, the connecting arm is defined with an extended width at contacting regions, to connect with the base member and the contact pad.

In an embodiment of the present disclosure, the connecting arm is defined with a narrow width along the partial circumference of the contact pad.

In an embodiment of the present disclosure, the contact pad is connected to the base member through the connecting arm such that, a gap is defined along a major circumference of the contact pad and the base member.

In an embodiment of the present disclosure, the connecting arm of one contact pad of the plurality of contact portions is farthest from the connecting arm from an adjacent contact pad.

In an embodiment of the present disclosure, the connecting arm is made of copper, and the metal substrate is made of tin.

In an embodiment of the present disclosure, during thermal runaway in the battery module, the metal substrate is configured melt and form an alloy with the connecting arm, to increase thermal conductivity of the connecting arm for fusing.

In an embodiment of the present disclosure, the busbar comprises a filler material provided between the connecting arm and the metal substrate, wherein the filler material is configured to melt and fix the metal substrate to the connecting arm.

In an embodiment of the present disclosure, at least a portion of the connecting arm is defined with a plurality of notches, wherein the connecting arm is configured to fuse about the at least one notch. The plurality of notches may be etched or grooved or pressed, in accordance with a defined pattern on the connecting arm. The defined pattern may be in either horizontal direction, vertical direction, oblique direction, and the like, on the connecting arm.

In yet another non-limiting embodiment of the present disclosure, a battery module is disclosed. The battery module includes a plurality of battery cells and a busbar. The busbar includes a base member, defining a plurality of contact portions. Each of the plurality of contact portions include a contact pad and a connecting arm extending between the contact pad and the base member, along a partial circumference of the contact pad. The busbar also includes a metal substrate, deposited along a portion of the connecting arm. The connecting arm and the metal substrate are configured to fuse, during thermal runaway in the battery module. Further, the battery module includes an insulator member positioned between the plurality of battery cells and the busbar. The insulator member prevents direct electrical and thermal contact of the busbar and at least one battery cell of the plurality of battery cells during thermal runaway. Additionally, the battery module includes a cover member positioned above the busbar. The cover member includes an elongated body defining a first major surface and a second major surface, where the second major surface is defined with a plurality of grooves. The cover member also includes a plurality of dimples are defined along at least one of the first major surface and the second major surface. Further, at least one dimple of the plurality of dimples melt and form an aperture when at least one battery cell of the battery module undergoes a thermal runaway, to fluidly connect the first major surface with the plurality of grooves. Also, the battery module includes a casing element, seated on the second major surface of the cover member, to cover the plurality of grooves.

In an embodiment of the present disclosure, the battery module comprises a battery cell frame, configured to accommodate each of the plurality of battery cells. The battery cell frame further includes a spacer element between each battery cell of the plurality of battery cells, to separate each of the at least one battery of the plurality of battery cells.

In an embodiment of the present disclosure, the plurality of grooves and the casing element are configured to route gases surrounding each of the plurality of battery cells, when at least one battery cell of the plurality of battery cells undergoes thermal runaway.

In an embodiment of the present disclosure, the number of contact portions in the busbar corresponds to the number of battery cells.

In an embodiment of the present disclosure, the insulator member is made of aramid polymer material.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings wherein like reference numerals represent like elements and in which:

FIG. 1 illustrates a perspective view a battery cell frame of a battery module including a battery cell, in accordance with an embodiment of the present disclosure.

FIG. 2A is a sectional perspective view of the battery module illustrating a cover member positioned on plurality battery cells, in accordance with an embodiment of the present disclosure.

FIG. 2B illustrates a sectional view of the battery module showing the battery cell frame, the cover member, an insulator member, and a busbar, in accordance with an embodiment of the present disclosure.

FIG. 3A illustrates a perspective view of the battery module showing the busbar and the plurality of battery cells, in accordance with one embodiment of the present disclosure.

FIG. 3B is a top view of FIG. 3A showing the busbar of the battery module.

FIG. 3C illustrates a detailed view of a metal substrate deposited on the busbar of FIG. 3A.

FIG. 3D illustrates a detailed view of a plurality of notches defined on the busbar of FIG. 3A.

FIG. 4 illustrates an exploded view of the battery module showing routing of gases within battery module, in accordance with an embodiment of the present disclosure.

FIG. 5 illustrates a sectional view the battery module employed with a casing element, in accordance with an embodiment of the present disclosure.

FIG. 6A illustrates a schematic perspective view of the battery module, in accordance with an embodiment of the present disclosure.

FIG. 6B is a sectional view of a portion of the battery module of FIG. 6A, illustrating arrangement of the plurality of battery cells in one or more stacks, in accordance with one embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

While the embodiments in the disclosure are subject to various modifications and alternative forms, specific embodiment thereof has been shown by way of example in the figures and will be described below. It should be understood, however, that it is not intended to limit the disclosure to the particular forms disclosed, but on the contrary, the disclosure is to cover all modifications, equivalents, and alternative falling within the scope of the disclosure.

It is to be noted that a person skilled in the art would be motivated from the present disclosure and modify various features of system, without departing from the scope of the disclosure. Therefore, such modifications are considered to be part of the disclosure. Accordingly, the drawings show only those specific details that are pertinent to understand the embodiments of the present disclosure, so as not to obscure the disclosure with details that will be readily apparent to those of ordinary skill in the art having benefit of the description herein.

The terms “comprises”, “comprising”, or any other variations thereof used in the disclosure, are intended to cover a non-exclusive inclusion, such that a device, system, method and assembly that comprises a list of components does not include only those components but may include other components not expressly listed or inherent to such system, method, or assembly, or device. In other words, one or more elements in a system or device proceeded by “comprises . . . a” does not, without more constraints, preclude the existence of other elements or additional elements in the system or device.

Embodiments of the present disclosure discloses a battery module. The battery module includes a plurality of battery cells and a busbar. The busbar includes a base member, defining a plurality of contact portions. Each of the plurality of contact portions include a contact pad and a connecting arm extending between the contact pad and the base member, along a partial circumference of the contact pad. The busbar also includes a metal substrate, deposited along a portion of the connecting arm. The connecting arm and the metal substrate are configured to fuse, during thermal runaway in the battery module. Further, the battery module includes an insulator member positioned between the plurality of battery cells and the busbar. The insulator member prevents direct electrical and thermal contact of the busbar and at least one battery cell of the plurality of battery cells during thermal runaway. Additionally, the battery module includes a cover member positioned above the busbar. The cover member includes an elongated body defining a first major surface and a second major surface, where the second major surface is defined with a plurality of grooves. The cover member also includes a plurality of dimples are defined along at least one of the first major surface and the second major surface. Further, at least one dimple of the plurality of dimples melt and form an aperture when at least one battery cell of the battery module undergoes a thermal runaway, to fluidly connect the first major surface with the plurality of grooves. Also, the battery module includes a casing element, seated on the second major surface of the cover member, to cover the plurality of grooves. This way, gases released or generated from the battery cells under thermal runaway are routed away from affecting adjacent or surrounding plurality of battery cells.

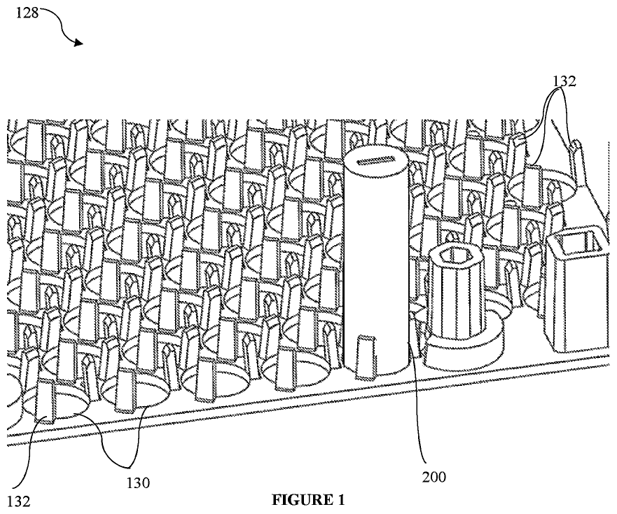

The following paragraphs describe the present disclosure with reference to FIGS. 1 to 6b. In the figures, the same element or elements which have similar functions are indicated by the same reference signs.

FIG. 1 illustrates a schematic diagram of a battery cell frame (128) [or also referred to as “cell frame (128)”] of a battery module (1000) for supporting a plurality of battery cells (200). The battery module (1000) may include a plurality of battery cells (200), where each battery cell of the plurality of battery cells (200) may be of a definite shape and configuration such as, but not limited to, cylindrical, cuboidal, triangular, pentagonal, and the like. The shape and configuration of each of the plurality of battery cells (200) may be uniform along the length, in order to suitably arrange each of the plurality of battery cells (200) in a defined order. The plurality of battery cells (200) may be arranged in one or more stacks or in arrays of the plurality of battery cells (200) [hereafter simply termed as “one or more stacks”], which may be configured to either individually or collectively provide electric energy. The plurality of battery cells (200) in each stack of the one or more stacks may be electrically inter-connected in at least one of a series connection, a parallel connection and a combination thereof. Further, the plurality of battery cells (200) in each stack of the one or more stacks in the battery module (1000) may consequently be electrically inter-connected in either series connection or in parallel connection, based on a number of parameters of the battery module (1000). The parameters may include, but may not be limited to, power rating of machineries to which power may be supplied from the battery module (1000), number of machineries connected to the battery module (1000) for operation, capacity of the battery module (1000), and the like.

The battery cell frame (128) may be configured to firmly clasp each battery cell of the plurality of battery cells (200). The battery cell frame (128) may include a plurality of receiving portions (130), which may be defined in a pre-determined pattern in the battery cell frame (128). The plurality of receiving portions (130) may profiled corresponding to the profile at either a top surface or a bottom surface of the plurality of battery cells (200). Further, each of the plurality of battery cells (200) may be insertable into the corresponding receiving portion (130) in at least one defined direction [that is, along the longitudinal direction of the battery cell]. This way, the plurality of receiving portions (130) may be configured to receive, locate and position each battery cell of the plurality of battery cells (200) in the battery cell frame (128). In an embodiment, each receiving portion (130) of the plurality of receiving portions (130) may be correspondingly designated to each battery cell of the plurality of battery cells (200) in the battery module (1000). However, it may also be noted that, the receiving portions (130) may be defined with a profile to resemble the plurality of battery cells (200). This profile aids in selectively accommodating each battery cell of the plurality of battery cells (200) in the battery cell frame (128). It this way, the profile of the plurality of receiving portions (130) may be varied, without deviating from the aspect of accommodating the plurality of battery cells (200). In the illustrative embodiment, each of the plurality of receiving portions (130) may be defined as a circular cavity in the battery cell frame (128), in order to receive and accommodate corresponding battery cell of the plurality of battery cells (200).

In an embodiment, in addition to the plurality of receiving portions (130), the battery cell frame (128) may also be defined with a plurality of fingers (132), for securing the plurality of battery cells (200) on the battery cell frame (128). The plurality of fingers (132) may be adapted to extend about each receiving portion (130) of the plurality of receiving portions (130) in the battery cell frame (128). The plurality of fingers (132) may laterally extend [that is, outwardly and perpendicularly extend] from a surface of the battery cell frame (128). Further, the plurality of fingers (132) may be defined about a peripheral region of each of the plurality of receiving portions (130), whereby the plurality of fingers (132) may be configured to engage and clasp the plurality of battery cells (200) positioned in the corresponding receiving portions (130) of the battery cell frame (128). In an illustrative embodiment, each of the plurality of fingers (132) are defined with a trapezoidal base profile, about which the plurality of fingers (132) are extending from the surface of the battery cell frame (128). The plurality of fingers (132) may be adapted to extend and incline at an angle of about 5° to about 45° [with respect to a vertical plane] and are orient towards each battery cell of the plurality of battery cells (200) positioned in the corresponding receiving portion (130). Further, each of plurality of fingers (132) are defined with a curved surface, where the curved surface may be defined along longitudinal axis of each of the plurality of fingers (132). Also, the curved surface may be defined proximal to the corresponding battery cell, in order to increase area of contact between the battery cell and the finger, whereby the increased area of contact results in increased pressure application on surface of engagement. This way, each of the plurality of battery cells (200) may be firmly secured on the battery cell frame (128). In the illustrative embodiment, each of the plurality of fingers (132) may be made of a material possessing elastic property so that, the plurality of fingers (132) may selectively deform in order to suitably accommodate corresponding battery cell on the battery cell frame (128). Also, the plurality of fingers (132) may be integrally defined with the battery cell frame (128).

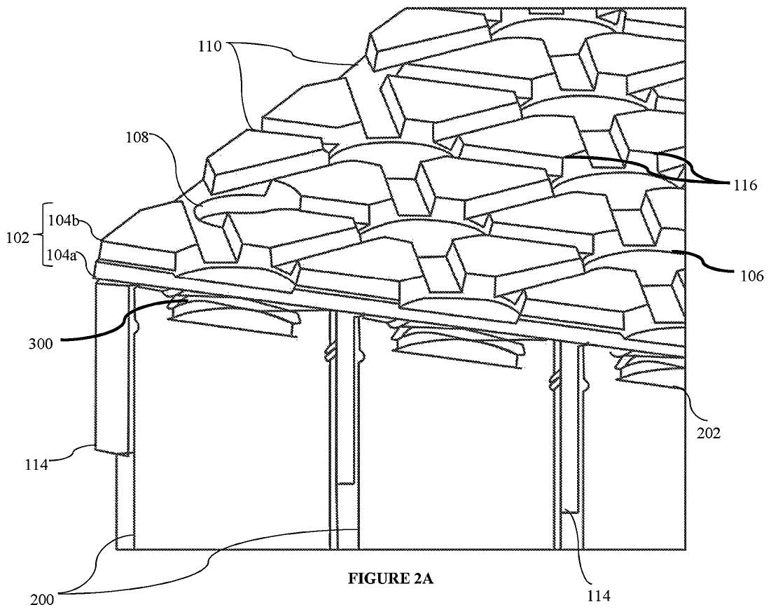

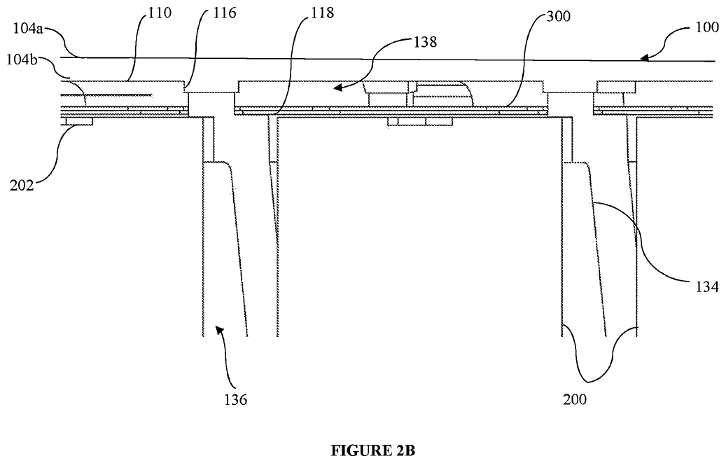

Further, in order to provide protection from entry of foreign particles into the battery module (1000), the battery module (1000) includes a cover member (100), as best seen in FIGS. 2A and 2B. The cover member (100) may be stratified with a busbar (300) and an insulator member (118), which may be positioned underneath therein. The cover member (100) may be adapted to partially enclose the plurality of battery cells (200) from a top surface. The cover member (100) includes an elongated body (102), which may overlay on the busbar (300), and in-turn on the plurality of battery cells (200), as best seen in FIG. 2B. The cover member (100) may be defined with a first major surface (104a) and a second major surface (104b), where the first major surface (104a) and the second major surface (104b) may be defined on opposite faces of the cover member (100). In an embodiment, the first major surface (104a) and the second major surface (104b) may be defined as a surface about width of the cover member (100), which may be traversed to extend along the length of the cover member (100). The first major surface (104a) may be adaptably positioned to face a terminal (202) of the plurality of battery cells (200), while the second major surface (104b) may be positioned distal from the terminal (202) of the plurality of battery cells (200). Further, either of the first major surface (104a) and the second major surface (104b) may be defined with a plurality of grooves (110). The plurality of grooves (110) may be defined such that, the plurality of grooves (110) forms an intersecting path above the adjacent battery cells (200) of the plurality of battery cells (200). Also, each groove of the plurality of grooves (110) may be separated by a ridge (116), that may be formed between each of the plurality of grooves (110). The ridge (116) may be configured to seat on a spacer element (114), provisioned proximal to the top surface of the plurality of battery cells (200), where the ridge (116) may be configured to define an air pocket (138) between the cover member (100) and the busbar (300). The air pocket (138) may be adapted to contain some of the gases generated or released from the plurality of battery cells (200).

In an embodiment, the spacer element (134), as best seen in FIGS. 2A and 2B, may be provided at a top surface of each of the plurality of battery cells (200), in order to separate and maintain uniform spacing between one battery cell from surrounding battery cells (200). This may complement the space defined by the plurality of receiving portions (130) at one end of each of the plurality of battery cells (200). Further, this space may provide necessary accommodative area for gases generated or released by the plurality of battery cells (200), during operation. In addition, the space may also act as an air-barrier (136), during thermal runaway of at least one battery cell of the plurality of battery cells (200). That is, the air-barrier (136) may absorb some quantity of heat from the gases generated or released by the plurality of battery cells (200), whereby minimizing conventional heat transfer from the gases to the surrounding battery cell of the at least one battery cell undergoing thermal runaway.

The cover member (100) may also include a plurality of dimples (106), where the plurality of dimples (106) may be defined along at least one of the first major surface (104a) and the second major surface (104b), as best seen in FIG. 2A. Particularly, the plurality of dimples (106) may be defined on the surface of the cover member (100) which may include the plurality of grooves (110). However, such configuration of the cover member (100) should not be construed as a limitation as the plurality of grooves (110) and the plurality of dimples (106) may be defined on opposite surfaces of the cover member (100) as well. In the illustrative embodiment, the plurality of dimples (106) and the plurality of grooves (110) are defined on the second major surface (104b) Each dimple (106) of the plurality of dimples (106) is located at the intersection of at least two grooves (110) of the plurality of grooves (110). In an embodiment, depth of each of the plurality of dimples (106) may be at least 15% to about 55% of a thickness of the elongated body (102). It may be noted that the thickness of the cover member (100) at each of the plurality of grooves (110) may be reduced in dimension to such as extent that parts of the cover member (100) may adaptably melt and form an aperture (108), due to the heat and gases released from the at least one battery during thermal runaway. In an embodiment, the cover member (100) may be made of a self-extinguishing polymeric material, where the cover member (100) may voluntarily extinguish any flame that may be caused due to combustion of the at least one battery undergoing thermal runaway.

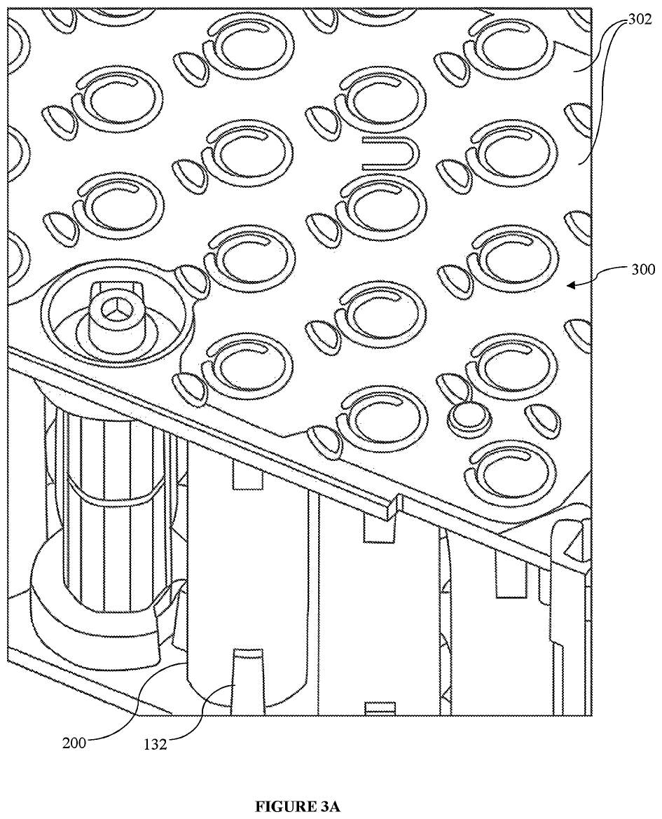

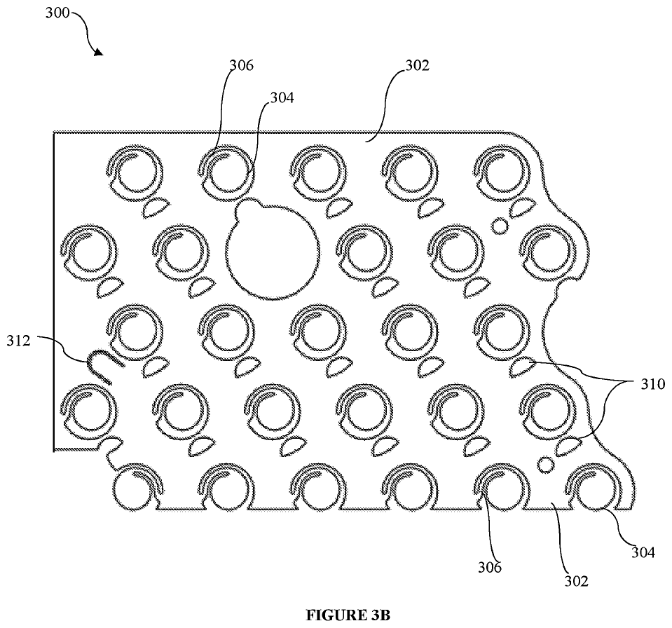

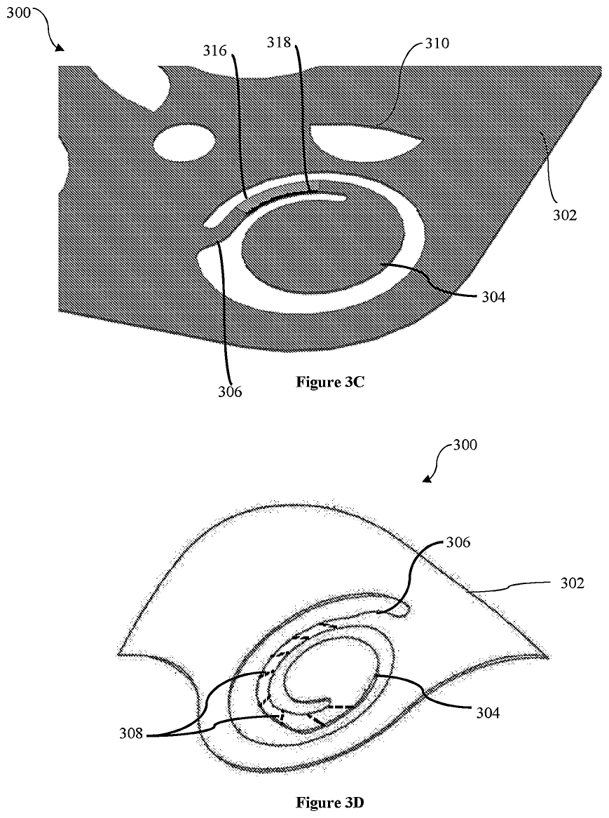

Referring again to FIG. 2B, as one end of each of the plurality of battery cells (200) may be secured in the battery cell frame (128), other end of each of plurality of battery cells (200) may be selectively engaged to an insulator member (118). The insulator member (118) may be adapted to engage [or overlay] with a peripheral lining [that is, proximal to edges] at the top surface of each of the plurality of battery cells (200). This way, a portion of each of the plurality of battery cells (200), such as that of the terminal (202) of each of the battery cell, may be exposed without being covered by the insulator member (118), as can be seen in FIG. 3. In this instance, the plurality of battery cells (200) may be electrically connectable for operation of the battery module (1000). In an exemplary embodiment, the plurality of battery cells (200) may be engaged to the busbar (300), for electrical connection. The busbar (300) may be positioned such that, only a portion of the busbar (300) to engage with each of the plurality of battery cells (200). By this, the insulator member (118) may be configured to inhibit direct electrical and thermal contact with the top surface of each of the plurality of battery cells (200), thereby avoiding localized electrical loops during thermal runaway of the at least one battery cell of the plurality of battery cells (200). In an embodiment, the insulator member (118) may be at least one of a thin film, a sheet, or a slab, which may be made of a polymer including, but not limited to, aramid polymer, in order to suitably be accommodated between the busbar (300) and the plurality of battery cells (200), without affecting overall thickness of the battery module (1000).

Turning to FIG. 3A, the busbar (300) may include a base member (302), which may be configured to seat on each of the plurality of battery cells (200). The busbar (300) may be adapted to be positioned on at least one of the top surface and the bottom surface of each of the plurality of battery cells (200) such that, the base member (302) may be discretely disposed between each of the plurality of battery cells (200) in each stack of the one or more stacks. Also, the base member (302) may be suitably connectable with the base member (302) of other stacks by means of electrical connection vide a plurality of wires [not shown in figures], based on defined operational configuration of the battery module (1000). This way, each of the one or more stacks may be electrically connectable in order to suitably supply power from the battery module (1000) to the article.

The base member (302) may define a plurality of contact portions, as can be best seen in FIG. 3B. The number of contact portions may correspond to number of battery cells (200). Each of the plurality of contact portions may include a contact pad (304) and a connecting arm (306). The contact pad (304) may be overhang [that is, suspended in air, when the contact pad (304) is not in engagement] from the base member (302), vide the connecting arm (306). The contact pad (304) may be engageable with the terminal (202) of corresponding battery cell of each of the plurality of battery cells (200), while the connecting arm (306) may be configured to electrically bridge the base member (302) and the terminal (202) of each of the plurality of battery cells (200). That is, the connecting arm (306) may be extended between the contact pad (304) and the base member (302), to connect the busbar (300) at the base member (302) and the plurality of battery cells (200) at the terminal (202), via the contact pads.

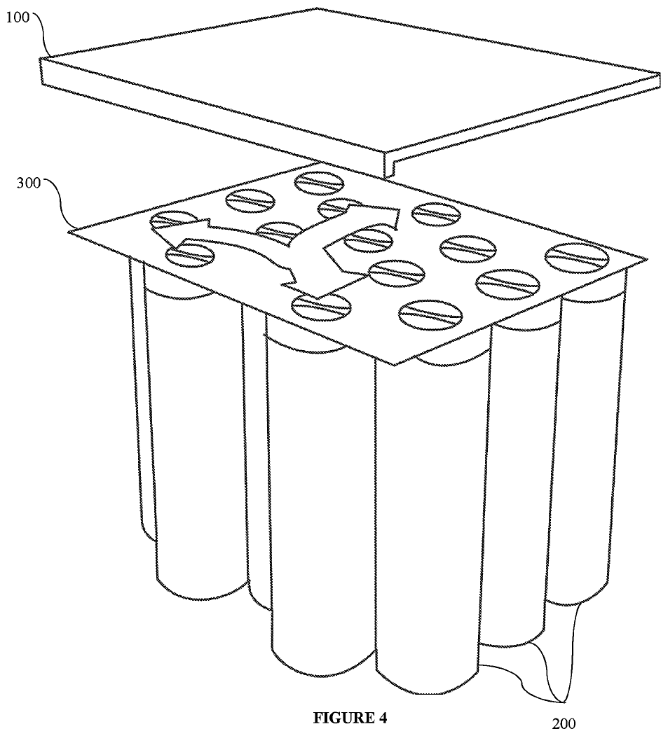

In the illustrative embodiment, the contact pad (304) of the busbar (300) may be annularly profiled, to resemble at least one of a circle and an ellipse, for engagement with the terminal (202) of each of the plurality of battery cells (200) [that is, completely covering the terminal (202) of the battery cell, and may extend beyond the periphery of the terminal (202)], as best seen in FIG. 4a. In addition, the connecting arm (306) is defined with an extended width initiating from the base member (302) and narrowing along a partial circumference of the contact pad (304), in order to increase the length of connection between the contact pad (304) and the base member (302). The increase in length the connecting arm (306) may enhance electrical resistivity and thermal conductivity, whereby increasing fusing function of the connecting arm (306) to assist when the battery cell corresponding to the contact pad (304) undergoes thermal runaway. Additionally, to improve fusing function of the connecting arm (306), a metal substrate (316) may be deposited along a portion of the connecting arm (306), as best seen in FIG. 3C. Here, it may be noted that, the portion of the connecting arm (306) may be referred to either an entire length of the connection arm, or a portion of the connecting arm (306) which is proximal to the contact pad (304) or a portion of the connecting arm (306) which is proximal to the base member (302). The portion of the connecting arm (306) should not be considered as a limitation, as the metal substrate (316) may be deposited to any extent on the connecting arm (306). Further, the metal substrate (316) may be joined to the connecting arm (306) with a filler material (318), where the filler material (318) may be fixed or sandwiched between the metal substrate (316) and the connecting arm (306). During thermal runaway, the filler material (318) may be configured to melt and fix the metal substrate (316) to the connecting arm (306). As the metal substrate (316) melts, the metal substrate (316) may be configured to form an alloy with the connecting arm (306), due to energy dissipation from the thermal runaway of the corresponding battery cell. The alloy formed may also increase thermal conductivity of the connecting arm (306), whereby reducing time period for fusing at the alloyed portion of the connecting arm (306) during thermal runaway. Due to this, the plurality of battery cells (200) surrounding [that is, may also be referred to as adjacent] the battery cell under thermal runaway may be electrically and thermally unaffected, as disruption of electrical and thermal contact with the busbar (300) may be transpired by fusing of the connecting arm (306). Also, the contact pad (304) may be connected to the base member (302) through the connecting arm (306) such that, a gap may be defined along a major circumference of the contact pad (304) and the base member (302), in order to facilitate travel of gases from the air-pocket. In an embodiment, the busbar (300) [that is, including the base member (302) and the contact portions] may be made of material including, but not limited to, copper, aluminum, silver, iron, nickel, graphite, and the like, whereas the metal substrate (316) may be including, but not limited to, tin. However, one should not consider the aforesaid as a limitation as the connecting arm (306) and the contact pad (304) of the busbar (300) may be made of dissimilar material from that of the base member (302), in order to suitably adapt to operational requirement of the busbar (300).

In one embodiment, each of the connecting arm (306) from the plurality of contact portions may be defined such that, portion of the connecting arm (306) extending from the base member (302) may be distally positioned from each of the neighbouring contact portion (314). Due to this distal positioning, heat transfer [that is, by mode of conduction] from one contact portion (314) to the plurality of contact portions surrounding therewith may be reduced, during thermal runaway of the battery cell associated with the one contact portion (314). This way, heat transfer within the busbar (300) may be maintained to a negligible value.

In one embodiment, at least a portion of the connecting arm (306) may be defined with a plurality of notches (308), as best seen in FIG. 3D. The plurality of notches (308) may be configured to impart or infuse thermal stress concentration on the connecting arm (306) such that, the connecting arm (306) may be configured to fuse about the at least one notch, during thermal runaway of corresponding battery cell of the plurality of battery cells (200). It may be noted that, the connecting arm (306) may be defined with the one or more notches (308) in conjunction with deposition of the metal substrate (316), for enhancing the fusing function of the connecting arm (306). However, each aspect of the connecting arm (306) [that is, providing the one or more notches (308) and deposition of the metal substrate (316)] may be independently employed for operation.

Turning now to FIG. 4, which illustrates a schematic view of battery module (1000) showing escape or exhaust routes of gases released from the plurality battery cells (200) and heat transfer during thermal runway. The gases may generally, be released from the bottom surface [that is, from a negative terminal (202) of the battery cell] of each of the plurality of battery cells (200), during operation of the battery module (1000). During thermal runaway of the at least one battery cell of the plurality of battery cells (200), the gases may attain latent heat. The gases may then rise from the bottom surface of the plurality of battery cells (200) and may travel towards the top surface. The gases may travel through the space defined between each of the plurality of battery cells (200) to reach the air pocket (138) at the top surface of the plurality of battery cells (200). Further, the gases in the air pocket (138) may engage with the cover member (100) and the busbar (300), to transfer the latent heat contained within. The busbar (300) may be adapted to receive and conduct the latent heat from the gases, while the cover member (100) may restrict transfer of heat. As the heat content in the gases may increase [that is, increase in heat content of the gases due to incessant operation of the battery module (1000)], the connecting arm (306) provided over the battery cell undergoing thermal runaway may fuse [or break or disable] in order electrically disconnect the at least one battery cell. Also, the cover member (100) may be selectively subjected to convectional and radiational heat transfer from the gases, due to which a portion of the cover member (100) corresponding to the battery cell under thermal runaway may melt about at least one dimple (106) to form the aperture (108). The aperture (108) may define a pathway that may connect the first major surface (104a) and the second major surface (104b) of the cover member (100), whereby providing a route for the gases to travel. Additionally, as the gases may be at an elevated temperature, the gases may possess kinetic energy for movement. The kinetic energy of the gases may allow movement from the space defined between the air-barrier (136) and the air-pocket in the battery module (1000), to travel along the plurality of grooves (110). This way, the busbar (300) and the cover member (100) may electrically and structurally disconnect the at least one battery cell undergoing thermal runaway from the surrounding plurality of battery cells (200).

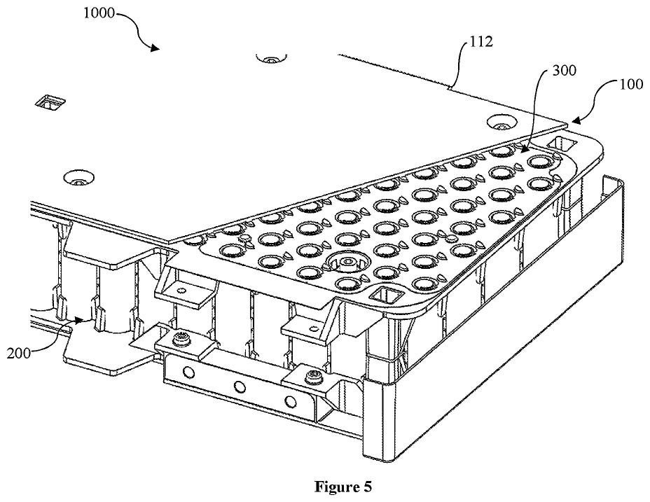

The gases which may be routed from the air pocket (138), through the cover member (100), may be restricted from further upward travel by a casing element (112), as best seen in FIG. 5. The casing element (112) maybe positioned proximal to the cover member (100) and may be positioned to abut the plurality of grooves (110) of the cover member (100). The casing element (112) may be configured to absorb and diffuse heat from the gases. The gases may then be dispersed over the cover member (100) and along the plurality of grooves (110) such that, the gases may not engage with the surrounding plurality of battery cells (200) to induce a concentrated heat zone within the battery module (1000). Additionally, a lateral opening [not shown in Figures] may be defined in the battery module (1000), to vent the gases therefrom.

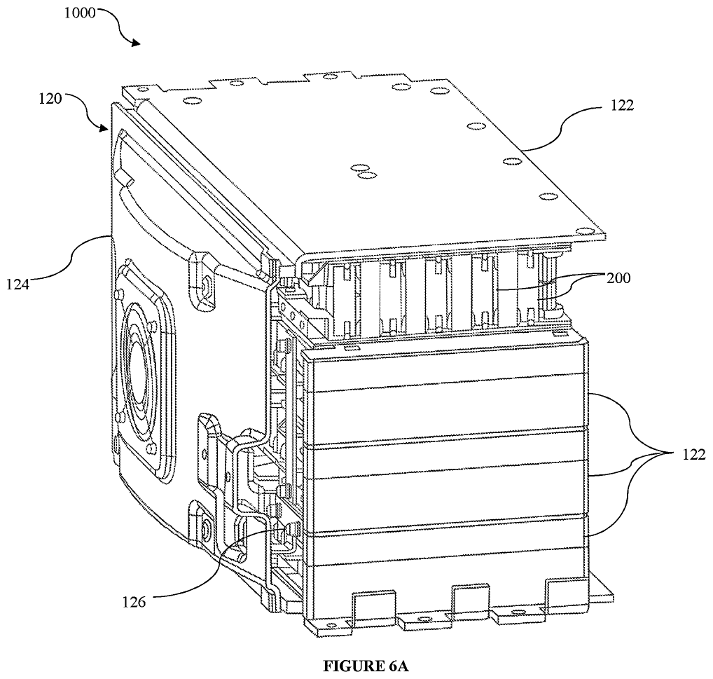

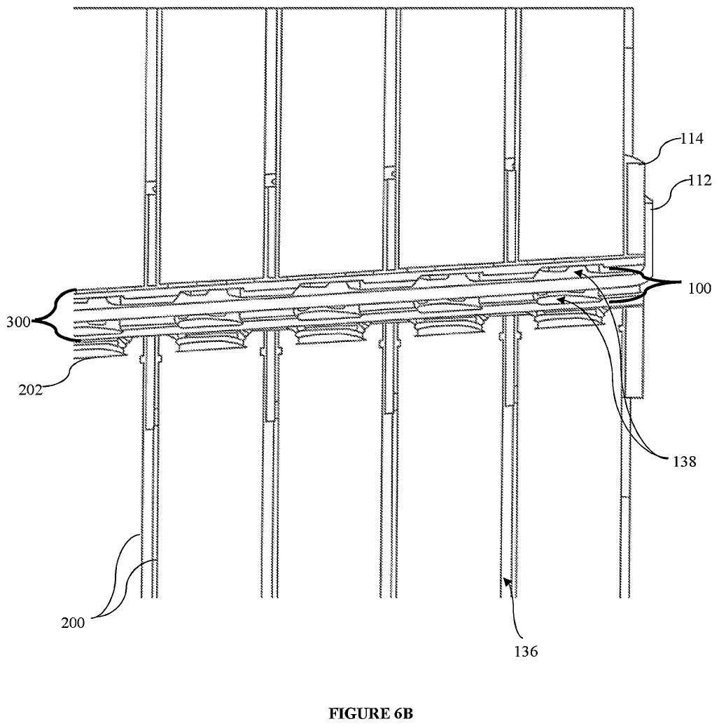

In an embodiment, the battery module (1000) may include a housing (120), as shown in FIG. 6A. The housing (120) may be configured to contain the one or more stacks to accommodate the plurality of battery cells (200) of the battery module (1000). In the illustrative embodiment, the housing (120) consists of a plurality of enclosure members (122), where each of the plurality of enclosure members (122) are joined with one another by means at least one of mechanical and thermal joining processes. The plurality of enclosure members (122) may be configured to secure the one or more stacks on at least four sides of the housing (120). That is, the plurality of enclosure members (122) may be provided on at least one of a top side, a bottom side, a left side and a right side of the one or more stacks, while a front side and a rear side of the one or more stacks may be covered by a supporting member (124). The supporting member (124) on either the front side or the rear side may be defined with at least one interface module [not shown in Figures], where the interface module may be configured to electrically connect the battery module (1000) with at least one of the article or a power source. Also, the interface module may be configured to provide an user interface for operating the battery module (1000) by an operator. Further, the housing (120) may be defined with provisions (126) to assist in discretely positioning each stack of the one or more stacks in the battery module (1000). The provisions (126) may be defined on at least one enclosure member, to resemble a door. The provisions (126) may be adapted to allow access to the plurality of battery cells (200) of at least one stack of the one or more stacks, on selective operation of the provisions (126). The provisions (126) may also be configured to allow removal or retraction of at least one stack of the one or more stacks from the housing (120), to allow access to the plurality of battery cells (200). This way, each stack of the one or more stacks may be adaptably independent in retrieval for servicing and/or replaceability, for incessant operation of the battery module (1000).

Turning now to FIG. 6B, which illustrates arrangement of the plurality of battery cells (200) in the one or more stacks. As described above, the insulator member (118), the busbar (300), the cover member (100), and the casing element (112) may be provided between each stack of the one or more stacks. The casing element (112) of one of the stacks may be intermediately disposed between the cover member (100) of two adjacent stacks [or another stack]. That is, another stack may include similar arrangement to the plurality of battery cells (200), however, the top surface of the plurality of battery cells (200) may be oriented downwards in order to engage with the casing element (112). This way, during thermal runaway of at least one battery cell in either of the one or more stacks, the gases are vented from the battery module (1000) without affecting operation of the plurality of battery cells (200) in the other stacks.

In one embodiment, the battery cell frame (128) may be made of materials including, but not limited to, polymer, ceramic, polystyrene, and other materials which may not be combustible and restrict heat transfer.

In one embodiment, the busbar (300) may be defined with one or more cut-outs (312). The one or more cut-outs (312) may be configured to receive and secure at least one sensor such as, but not limited to, thermistors, infrared sensors, thermocouples, and the like, where the sensors may assist in detecting or determining thermal runaway of at least one battery cell of the plurality of battery cells (200). In the illustrative embodiment, the one or more notches (308) are defined with a U-profile, as best seen in FIG. 4b.

In one embodiment, the busbar (300) may be defined with a plurality of slots (310), where the slots (310) may be configured to receive a lug, to rigidly fix the busbar (300) with respect to the battery cell frame (128). This way, electrical connection between the busbar (300) and the plurality of battery cells (200) may be constantly maintained.

In an embodiment, a portion of the base member (302) or the connecting arm (306) may be fixed to the peripheral lining of each of the plurality of battery cells (200) by means such as, but not limited to, tig welding, spot welding, and the like. By this, the base member (302), and in-turn the busbar (300), may be rigidly fixed to each of the plurality of battery cells (200), for structural contact between the contact pad (304) and the terminal (202) of the plurality of battery cells (200).

In one embodiment, the casing element (112) may be including, but not limited to, aluminum, steel, copper, silver, and the like. It may be noted that the casing element (112) may be selected such that thermal conductivity of the casing element (112) may be higher than that of the cover member (100), in order to diffuse heat transferred from the gases.

In one embodiment, it may be noted that, securement means for securing the plurality of battery cells (200) with the battery cell frame (128) may be including, but not limited to, fastening, adhesive bonding, and the like. Also, the plurality of fingers (132) may define a space between each receiving portion (130) of the plurality of receiving portions (130).

In an embodiment, battery module (1000) may be employed to operate machineries including, but not limited to, components in vehicles, power tools, machineries, and the like. The vehicles may be such as, but not limited to, maritime vehicle, ferries, electric cars, and the like, while the machineries may be oil rigs, drive means such as engines, air-conditioning unit, pumping unit, and the like. However, such application of the battery module (1000) may not be limited to aforementioned fields, as the same may be employable in various technological domains including, but not limited to, biotechnology, robotics, solar energy units, and the like.

### Equivalents:

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERAL

Cover member (100)
Elongated body (102)
First major surface (104a)
Second major surface (104b)
Plurality of dimples (106)
Aperture (108)
Plurality of grooves (110)
Casing element (112)
Spacer element (114)
Ridge (116)
Insulator member (118)
Housing (120)
Enclosure members (122)
Supporting member (124)
Provision (126)
Battery cell frame (128)
Receiving portion (130)
Fingers (132)
Spacer element (134)
Air-barrier (136)
Air pocket (138)
Plurality of battery cells (200)
Terminal (202)
Busbar (300)
Base member (302)
Contact pad (304)
connecting arm (306)
notches (308)
slots (310)
cut-out (312)
contact portion (314)
metal substrate (316)
filler material (318)
Battery module (1000)

1-23. (canceled)

24. A cover member for a battery module, the cover member comprising:
an elongated body defining a first major surface and a second major surface, wherein the second major surface is defined with a plurality of grooves; and
a plurality of dimples defined along at least one of the first major surface and the second major surface, wherein, each dimple of the plurality of dimples is positioned at an intersection of at least two grooves of the plurality of grooves, and wherein at least one dimple of the plurality of dimples melts and form an aperture when at least one battery cell of the battery module undergoes a thermal runaway, to fluidly connect the first major surface with the plurality of grooves.

25. The cover member as claimed in claim 24, wherein each groove of the plurality of grooves is separated by a ridge defined on the second major surface.

26. The cover member as claimed in claim 24, wherein the plurality of grooves is enclosable by a casing element abutting the second major surface of the elongated body, upon connecting the casing element with the cover member.

27. The cover member as claimed in claim 26, wherein thermal conductivity of the elongated body is lower than the casing element.

28. The cover member as claimed in claim 24, wherein the elongated body is made of a self-extinguishing polymer material.

29. The cover member as claimed in claim 24, wherein each of the plurality of dimples is defined in a portion of the elongated body, between the first major surface and the second major surface.

30. The cover member as claimed in claim 24, wherein depth of each of the plurality of dimples is at least 15% to about 55% of a thickness of the elongated body.

31. A busbar for a battery module, comprising:
a base member defining a plurality of contact portions, each of the plurality of contact portions comprising:
a contact pad;
a connecting arm extending between the contact pad and the basemember along a partial circumference of the contact pad; and
a metal substrate, deposited along a portion of the connecting arm, wherein the connecting arm and the metal substrate are configured to fuse, during thermal runaway in the battery module;
wherein, the connecting arm is made of copper, and the metal substrate is made of tin.

32. The busbar as claimed in claim 31, wherein the connecting arm is configured to fuse and disable connection between the contact pad and the base member.

33. The busbar as claimed in claim 31, wherein the connecting arm is defined with an extended width at contacting regions relative to width of the base member, to connect with the base member and the contact pad.

34. The busbar as claimed in claim 33, wherein the connecting arm is defined with a narrow width along the partial circumference of the contact pad, relative to the extended width of the connecting arm at the contacting regions.

35. The busbar as claimed in claim 31, wherein the contact pad is connected to the base member through the connecting arm such that, a gap is defined along a major circumference of the contact pad and the base member.

36. The busbar as claimed in claim 31, wherein the plurality of contact portions are oriented such that, the connecting arm of one contact pad is farthest from the connecting arm from an adjacent contact pad.

37. The busbar as claimed in claim 31, wherein the metal substrate is configured melt and form an alloy with the connecting arm, during thermal runaway in the battery module to increase thermal conductivity of the connecting arm for fusing.

38. The busbar as claimed in claim 31, comprises a filler material provided between the connecting arm and the metal substrate, wherein the filler material melts and fixes the metal substrate to the connecting arm, during thermal runaway in the battery module.

39. The busbar as claimed in claim 31, wherein at least a portion of the connecting arm is defined with a plurality of notches, wherein the connecting arm is configured to fuse about the at least one notch.

40. A battery module, comprising:
a plurality of battery cells;
a busbar, including a base member defining a plurality of contact portions, is disposed on the plurality of battery cells, wherein each of the plurality of contact portions comprising:
a contact pad; and
a connecting arm extending between the contact pad and the base member along a partial circumference of the contact pad; and
a metal substrate, deposited along a portion of the connecting arm, wherein the connecting arm and the metal substrate are configured to fuse, during thermal runaway in the battery module;
an insulator member positioned between the plurality of battery cells and the busbar, to prevent direct electrical and thermal contact of the busbar and at least one battery cell of the plurality of battery cells during thermal runaway; and
a cover member positioned above the busbar, the cover member comprising:
an elongated body defining a first major surface and a second major surface, wherein the second major surface is defined with a plurality of grooves; and
a plurality of dimples defined along at least one of the first major surface and the second major surface, wherein at least one dimple of the plurality of dimples melts and form an aperture when at least one battery of the battery module undergoes a thermal runaway, to fluidly connect the first major surface with the plurality of grooves in the second major surface; and
a casing element seated on the second major surface of the cover member, to cover the plurality of grooves.

41. The battery module as claimed in claim 40 comprises a battery cell frame, configured to accommodate each of the plurality of battery cells, wherein the battery cell frame includes a spacer element between each battery cell of the plurality of battery cells, to separate each of the at least one battery cell of the plurality of battery cells.

42. The battery module as claimed in claim 40, wherein the plurality of grooves and the casing element are configured to route gases surrounding each of the plurality of battery cells, when at least one battery cell of the plurality of battery cells undergoes thermal runaway.

43. The battery module as claimed in claim 40, wherein the number of contact portions corresponds to the number of battery cells.

44. The battery module as claimed in claim 40, the insulator member is made of aramid polymer material.
